(19) United States
(12) Patent Application Publication
(10) Pub. No.: US 2006/0029531 A1
(43) Pub. Date: Feb. 9, 2006

(54) Method of removing mercury from flue gas through enhancement of high temperature oxidation

(76) Inventors: Bernard P. Breen, Pittsburgh, PA (US); Robert A. Schrecengost, Beaver, PA (US); Stephen Niksa, Belmont, CA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/910,029

(22) Filed: Aug. 3, 2004

(51) Int. Cl. B01D 53/64

(52) U.S. Cl. 423/210

(57) ABSTRACT

In a method for removing mercury from flue gas produced by combustion devices burning coal and other fuels that contain mercury and chlorine the combustion process is controlled to generate a flue gas comprising fly ash containing at least 0.25% unburned carbon, and preferably at least 5.0% unburned carbon. In addition the flue gas is rapidly cooled from a temperature within the range of 1450° F. to 900° F. to a temperature below 900° F. at a rate of at least 1000° F. per second. This step will enhance the concentrations of Cl-atoms and Cl₂, which accelerates the rates of mercury oxidation in both the gas phase and on particle surfaces. Finally, the flue gas is directed to the particle removal device for removal of the fly ash to which some of the mercury is bound, and also directed to a wet scrubber for retention of the oxidized mercury vapor in wastewater and solid effluents.

### FIELD OF INVENTION

The invention relates to a process to reduce emissions of mercury from coal fired furnaces and other devices that burn fuels containing mercury.

### BACKGROUND OF THE INVENTION

Mercury is identified as a hazardous air pollutant and is the most toxic volatile metal in the atmosphere. Elemental mercury vapor can be widely dispersed from emission sources. Other forms of mercury pollutants include organic and inorganic compounds that accumulate in plants and animals. Mercury is a constituent part of coal mineral matter. Its emission from coal-fired power plants is suspected to be a major anthropogenic source of environmental mercury. Consequently, substantial effort has been made to develop devices and methods that will remove mercury from flue gas before the flue gas is released into the atmosphere.

Mercury is emitted in power plant flue gases because the elemental form is almost completely insoluble in water and flue gas desulfurization (FGD) scrubbing solutions. As such, the elemental mercury is either emitted as a vaporous gas, Hg(v), which is very difficult to separate or filter, or adsorbed onto flyash particulates and sorbents. If the mercury is oxidized it is Hg²⁺, which readily dissolves in water and FGD scrubbing solutions. Moreover, the oxidized form of mercury dissolved in aqueous scrubbing solutions is retained in wastewater streams and on suspended solids. Those streams are collected at very high efficiency with routine handling procedures. Any oxidized or elemental mercury bound to particulates is also removed with very high efficiency in electrostatic precipitators, baghouse filters, or cyclones. So almost all the mercury emitted from coal-fired power stations leaves the smokestack as elemental mercury vapor.

Consequently, most of the techniques which have been proposed for removing mercury from flue gas involve some action to prompt the formation of mercuric chloride, HgCl₂ also called mercury chloride, and thereby minimize the amount of elemental mercury vapor. Perhaps the most obvious technique is to inject chlorine or a chlorine compound into the mercury containing flue gas. U.S. Pat. No. 6,447,740 describes a method for removing mercury from flue gas in which chlorine is injected into the flue gas. In a somewhat similar method disclosed by Ocher in United States Published Application No. U.S. 2004/0161771 a molecular halogen, such as chlorine gas, or molecular halogen precursor, such as calcium hypochlorite solution, is injected into the flue gas. However, chlorine is so corrosive to metals that furnace operators are reluctant to add chlorine in any form to a combustion system for controlling mercury emissions.

Another technique uses activated carbon and other fine particulates to absorb mercury. In this method carbon is impregnated with a halogen species, such as chlorides, iodine and/or sulphides. Unfortunately, the use of activated carbon requires extremely high carbon to mercury ratios. For that reason, collection by the use of activated carbon is very expensive.

Lanier et al. in published United States Patent Application No. U.S. 2004/0134396 observe that mercury emissions from flue gas containing fly ash that contains unburned carbon are lower than mercury emissions from flue gas containing fly ash that contains no unburned carbon. They attribute this result to a reaction between mercury and char that results in mercury being bound on the surface of the char. Therefore, they teach several techniques for controlling the operation of a coal burning furnace to increase the amount of unburned carbon in the fly ash and thereby reduce mercury emission. But, the highest amount of mercury capture reported by Lanier et al. was 43.7%.

Consequently, there continues to be a need for a method of removing mercury from flue gas that does not introduce corrosive materials into the combustion system and removes most, if not all, of the mercury from the flue gas.

### SUMMARY OF THE INVENTION

We provide a method for removing mercury from flue gas produced by combustion devices burning coal and other fuels, such as municipal waste, that contain mercury and chlorine. In these devices the fuel is burned in a combustion zone in which the temperature exceeds 2600° F. Combustion produces flue gas containing fly ash that is directed through a first temperature zone in which the temperatures range from 1750° F. to 2100° F., through a second temperature zone in which the temperatures range from 900° F. to 1450° F., through a particle removal device, and through a wet scrubber.

First, we control the combustion process to generate a flue gas comprising fly ash containing at least 0.25% unburned carbon, and preferably at least 5.0% unburned carbon. Any of the several techniques for enhancing unburned carbon content in fly ash disclosed in published United States Patent Application No. U.S. 2004/0134396 could be used. Typically, the control would involve an adjustment to the operation of one or more burners in the furnace.

Next, we rapidly cool the flue gas from a temperature within the range of 1450° F. to 900° F. to a temperature below 900° F. at a rate of at least 1000° F. per second. This step will enhance the formation of mercury chloride, both in the flue gas and on the surfaces of the unburned carbon in the fly ash. Whereas the amount of mercury chloride is enhanced, the amount of elemental mercury vapor is reduced in inverse proportion. Once the mercury chloride and mercury bound to particles in the flyash are recovered in conventional exhaust system components, there is less elemental mercury vapor to be emitted from the smokestack.

Other objects and advantages of the present method will become apparent from the description of certain present preferred embodiments thereof which are illustrated by the accompanying drawings.

### BRIEF DESCRIPTION OF THE FIGURES

FIG. 1 is a graph showing the effect of the chlorine content in coal upon the concentration of chlorine radicals at a temperature of 933K (1220° F.).

FIG. 2 is a graph showing the extent of mercury oxidation at 922° C. for a range of quench rates from 100° C. to 7,000° C. per second for two gas samples.

FIG. 3 is a graph showing mercury capture over a temperature range from 600° F. to 1350° F.

FIG. 4 is a diagram of a typical wall-fired furnace with features added that can be used to practice the present method.

FIG. 5 is a graph of elemental mercury present in the flue gas at various temperatures.

FIG. 6 is a graph comparing elemental mercury present in flue gas at various temperatures as reported in the literature.

FIG. 7 is a graph similar to FIG. 5 showing observed mercury levels at various temperatures.

FIG. 8 is a graph of simulation results for mercury oxidation at selected cooling rates for three flue gases having different levels of unburned carbon in the fly ash.

FIG. 9 is a graph of predicted chlorine atom concentrations over time for four selected cooling rates.

### DESCRIPTION OF THE PREFERRED EMBODIMENTS

In the inventive process we oxidize mercury with chlorine to HgCl₂, HgCl, HgO and other species, but we believe that the HgCl₂ is the predominant oxidized specie. We believe that HCl is released from the burning coal, and subsequently partially decomposes into atomic (Cl) and molecular (Cl₂) chlorine that oxidize mercury in the gas phase. We believe that HCl also chlorinates sites on the surfaces of unburned carbon and some of the minerals in flyash, and that these chlorinated sites also oxidize elemental mercury into mercuric chloride, HgCl, which subsequently leaves the surface and oxidizes to HgCl₂. The Cl and Cl₂ concentrations are dependent upon the HCl concentration, the OH concentration, and the temperature as well as several other species. The reaction pathway to mercuric chloride in the gas phase is said by Widmer to be:
Hg+Cl+M=HgCl
HgCl+Cl₂=HgCl₂+Cl
The reaction pathway to mercuric chloride on the particle surfaces is said by Niksa to be:
HCl+S-Open=S—Cl+Cl
S—Cl+Hg=HgCl
HgCl+Cl₂=HgCl₂+Cl
S-Open denotes an unoccupied site and S—Cl denotes a chlorinated site on the particle surface. The surface is chlorinated by HCl, the most abundant Cl-species in coal-derived exhausts, and the large storage capacity of carbon for chlorine ensures that a source of chlorine will be present to oxidize mercury over a broad temperature range. Chlorinated sites partially oxidize mercury into HgCl, which then leaves the surface. In the gas phase, the HgCl is completely oxidized to HgCl₂ by Cl₂, as indicated above, or the HgCl may be decomposed by OH into elemental mercury vapor. Provided there is a relative abundance of Cl₂, mercury oxidation on particle surfaces converts elemental mercury vapor into mercuric chloride.

The chlorine species for both reaction paths come from chlorides in the coal. All coal contains some chlorine but the concentration may be from 0.05 to 1.0% in UK coals. U.S. coals have lower chlorine content and are usually less than 0.3%. Powder River Basin coals typically have chlorine concentrations of 0.03%. We have observed that the mercury emissions will decrease with increasing chlorine in the coal.

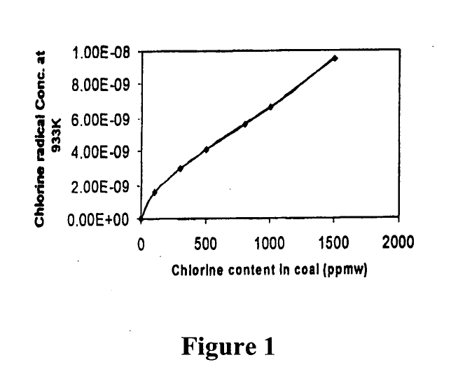

To calculate the species concentrations at various temperatures we have used the CHEMKIN36 software library and a detailed kinetic mechanism for coal combustion flue gas reactions, comprised of 51 species and 289 reaction steps. The calculation of the concentration of Cl as a function of chlorine in the coal is shown in FIG. 1. This is for a flue gas experiencing the usual cooling path for flue gas passing through a boiler and having the typical gas concentrations (14.44% CO₂, 5.69% water vapor, 3.86% O₂ and 75.69% N₂). This is the Cl concentration at 933 K (1220° F.), which is near the upper temperature where HgCl₂ will form.

FIG. 1 shows that the level of chlorine atoms in flue gas is directly related to the amount of chlorine in the coal. Similarly, the amount of Cl₂ in flue gas increases in direct proportion to the level of chlorine atoms, because Cl₂ is the recombination product of Cl-atoms. Consequently, many coals can be the source of the chloride needed to form mercuric chloride from the mercury in the coal that enters the flue gas. The objective is to cause the chlorine in the coal to react with most if not all of the mercury to form mercuric chloride that does not later decompose to elemental mercury, but instead will either bond to the fly ash and be removed by the particle removal device, or dissolve and be collected in scrubbing solutions. But, as one can see from the reported levels of emissions of mercury from coal burning furnaces this result does not occur in most furnaces today. We attribute that fact to the absence of sufficient chlorine atoms and molecules which are available to bond with mercury in temperature ranges where the reaction pathways to mercuric chloride described by Widmer and Niksa will be followed, and to decomposition of mercury chloride that is formed as the flue gas is cooled.

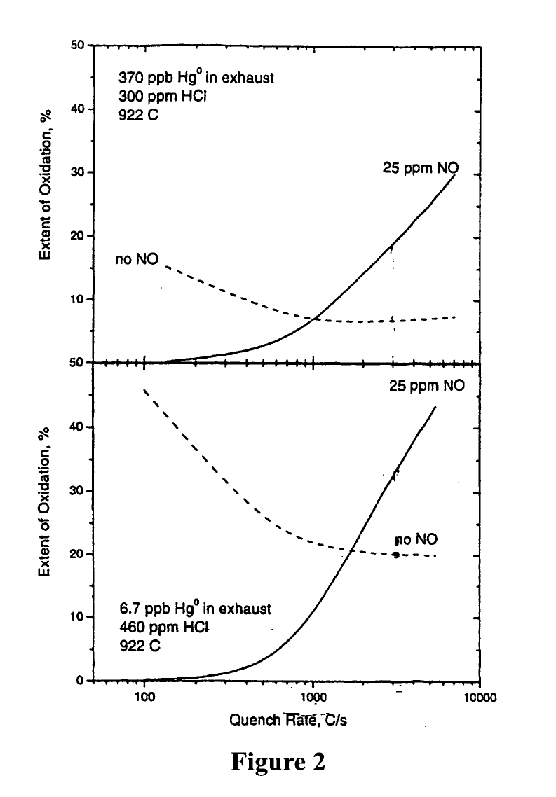

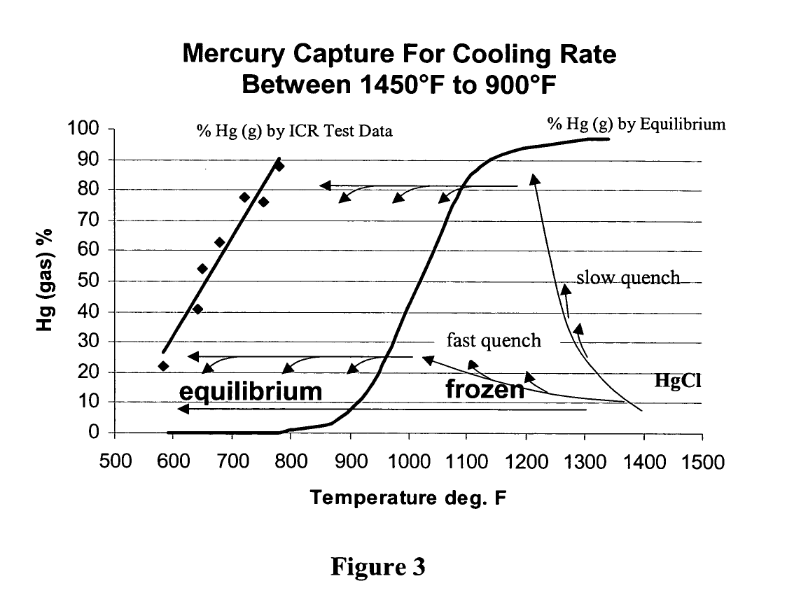

FIG. 2 is a graph of calculated percentages of mercuric chloride reported by Niksa et al. of the oxidation of mercury at various quench rates. See “Kinetic Modeling of Homogeneous Mercury Oxidation,” S. Niksa, J. Helble and N. Fujiwara, Environmental Science and Technology, 2001. The graphs show that at cooling rates above about 500° C. per second (932° F. per second), more of the mercury is present as mercuric chloride. From this data we concluded that one could improve the amount of mercury capture from flue gas by not only forming mercury chloride in the 1005K (1,350° F.) to 755K (900° F.) temperature range, but also by rapidly cooling the flue gas from temperatures within that range to temperatures below 500° C. The improvement is graphically shown in FIG. 3.

Referring to FIG. 3 the initial conditions are that mercury chloride is present in the flue gas at a temperature of about 1350° F. (732° C.). As can be seen from the lower right of FIG. 3, only about 15% of the mercury in that flue gas is in elemental vapor form, the remainder being in the form of mercury chloride. If the flue gas is rapidly cooled as indicated by the “fast quench” arrows, then the mercury chloride is frozen and does not decompose to elemental mercury vapor. Cooling occurs so rapidly that there is no time for such decomposition. On the other hand, if the flue gas is cooled slowly, that “slow quench” will result in decomposition of the mercury chloride. That slow quench results in almost 90% of the mercury being in elemental vapor form. Since elemental mercury vapor is much more difficult to remove than mercury which has been oxidized to mercury chloride, a “fast quench” should be used.

Faster quenching also enhances the rate of mercury oxidation on particle surfaces, even though this so-called “heterogeneous reaction mechanism” occurs in a lower temperature window than Cl-atom activation. Faster quenching increases the concentration of Cl-atoms, as previously illustrated in FIG. 1. Whenever more Cl-atoms are present at higher temperatures, then more Cl₂ will be generated by the time the flue gas is cooled into the cooler temperature range for mercury oxidation on particle surfaces. A relative abundance of Cl₂ rapidly stabilizes the HgCl released from the particle surfaces into HgCl₂, and prevents the HgCl from decomposing into elemental mercury vapor via its reaction with OH radicals. Faster quenching thereby elevates the levels of Cl₂ that are available to stabilize the HgCl from particle surfaces as stable mercuric chloride. Since the HgCl₂ is formed at the low temperatures of heterogeneous mercury oxidation, it cannot decompose further into elemental mercury vapor, and will therefore ultimately be retained, in part on particulates or, in part in scrubbing solutions.

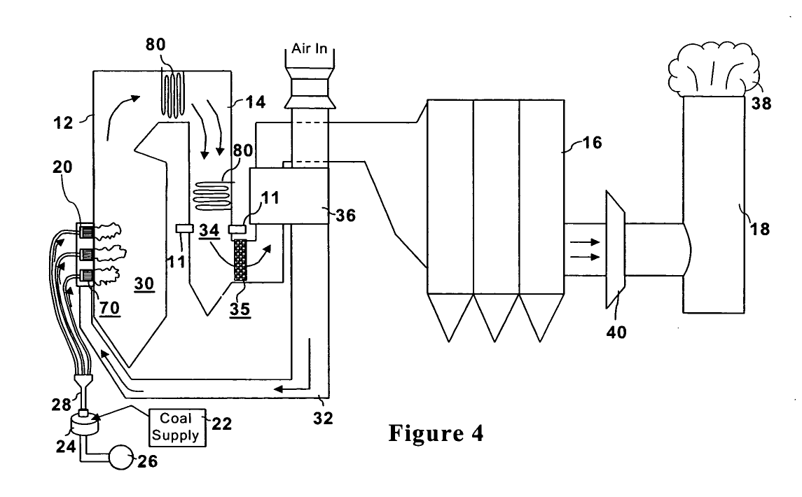

Referring to FIG. 4, a conventional furnace generally includes a boiler 12, an economizer 14, an electrostatic precipitator (ESP) 16 and a stack 18. The boiler 12 includes a plurality of burners 20 typically located on the front and/or rear walls of the boiler 12. For convenience, only three burners 20 are shown in FIG. 4 but many more would be present in most industrial furnaces.

Operation of the boiler 12 requires a supply of fuel to be burned, such as a coal supply 22. The coal supply 22 supplies coal at a predetermined rate to a pulverizer 24, which grinds the coal to a small size sufficient for burning. The pulverizer 24 receives a primary flow of air from a primary air source 26. Only one pulverizer 24 is shown, but many are required for a large boiler, and each pulverizer 24 may supply coal to many burners 20. A stream of primary air and coal is carried out of the pulverizer 24 through line 28. The primary stream of air and coal in line 28 is fed to the burner 20, which burns the fuel/air mixture in a combustion zone 30 in which the temperature exceeds 1700K (2,600° F.).

To assist in the burning, the boiler 12 includes a secondary air duct 32 providing a secondary airflow through overfire air ports to the burner 20. Usually about 20% of the air required for optimum burning conditions is supplied by the primary air source 26. The secondary air duct 32 is used to provide the remaining air. The secondary air duct 32 brings the excess air in from the outside via a fan (not shown) and the air is heated with an air preheater 36 prior to providing the air to the burner 20.

While only three burners 20 are shown in FIG. 4, it should be understood that there are typically many more burners spaced about the boiler 12 in a conventional furnace. Several burners 20 may share a secondary air windbox, and each burner 20 usually has an adjustable secondary air register 70 to control the air flow to it. Each of the burners 20 burns its respective fuel/air mixture in the combustion zone 30 of the boiler 12. As the plurality of burners 20 burn their respective fuel/air mixtures in the combustion zone 30, a gaseous by-product, typically known as flue gas, is produced. The gaseous by-product flows in the direction of the arrows through various temperature zones out of the boiler 12, through the economizer 14, through the ESP 16 and into the stack 18 where it is exhausted to the atmosphere at 38. A fan 40 aids the flow of the gaseous by-product in this manner. Various processing and testing procedures are performed on the flue gas as it flows from the boiler 12 through the various furnace elements and is exhausted by the stack 18. However, these procedures and tests are conventional in the art and descriptions thereof are not necessary. The flue gas is also used to heat steam and water in convective passes 80, as is known in the art.

While we have shown an opposed fired boiler 12 in FIG. 4, the inventive method works as well on various types of boilers, including, but not limited to, single face fired boilers, tangentially fired boilers, and cyclone fired boilers. While the opposed fired, single face fired, and tangentially fired boilers typically utilize a pulverized fuel, the cyclone fired boilers typically do not.

The cooling rate of the flue gas as it passes through the economizer is dependent upon the tube configuration and other design aspects of the economizer. Some economizers currently in service can cool flue gas at rates greater than 3000° F. per second (1649° C. per second). Adding fins to the cooling tubes can usually increase the rate of cooling. Therefore, it should be possible to use the present method in many furnaces without substantially modifying the furnace or adding expensive gas cleaning units to the exhaust system. If the economizer in an existing furnace has a slow cooling rate and a higher cooling rate is desired to achieve maximum mercury removal, it can be accomplished by adding fins to the economizer cooling tubes. Alternatively, a heat transfer grid 35 or other structure may be placed in a temperature zone 34 as shown in FIG. 4 to rapidly cool the flue gas prior to the entry of the flue gas into the ESP 16.

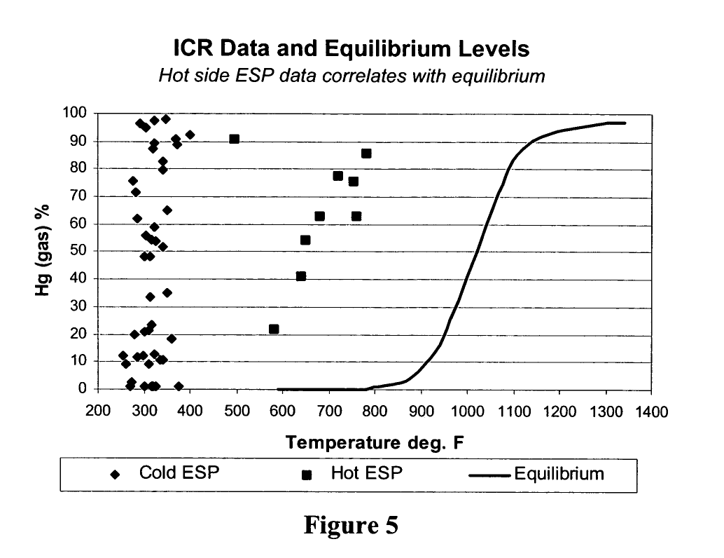

The currently unregulated cooling rates of flue gas in the superheaters and economizers of operating coal-fired power stations are partially responsible for broad variations in the extents of mercury oxidation. Reported extents of Hg oxidation span the range of possible values, as seen in the ICR data in FIG. 5. Attempts to simply correlate these data with selected coal properties and operating conditions failed (r²<0.5). Our interpretation for an important subset of these data forms the basis of the inventive method to significantly enhance mercury oxidation in flue gas.

As seen in FIG. 5, the proportion of elemental mercury vapor does not correlate at all with temperatures downstream of an air heater, which are the inlet values to cold-side ESPs (cESP). But where a hot-side ESP (hESP) was the last air pollution control device (APCD), the ICR datasets reported the inlet temperatures, which are economizer outlet temperatures. For these cases, the proportion of elemental mercury vapor increases for progressively hotter temperatures as seen in FIG. 5. The relation has the same slope as the equilibrium vapor speciation curve, but is displaced toward cooler temperatures by about 200-300° F. The underlying cause of this relationship is that faster flue gas quenching rates, evident in the ICR datasets as cooler HESP inlet temperatures, significantly promote mercury oxidation. Conversely, inlet temperatures to cESPs appear to be unrelated to Hg oxidation due to the confounding impact of air heaters.

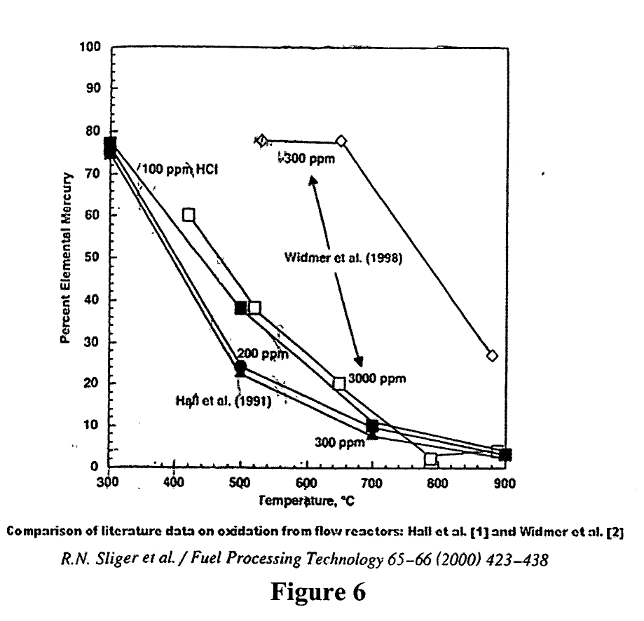

The premise that faster gas quenching accelerates Hg oxidation directly connects to several validated observations in lab-scale testing that HgCl₂ concentrations at temperatures above 1200° F. are far greater than the equilibrium levels (See: Hall, B.; Schager, P.; Lindqvist, O. Water, Air, and Soil Pollution 1991, vol. 56, pp. 3-14 and Widmer, N. C.; Cole, J. A.; Seeker, W. R.; Gaspar, J. A. Combust. Sci. Tech. 1998, vol. 134, pp. 315-326.). In FIG. 6, Hall's data (1) indicates 90% HgCl₂ above 700° C. (1292° F.), versus no HgCl₂ at equilibrium. This finding was later verified by both Widmer et al. and by Sliger et al. (Sliger, R. N.; Kramlich, J. C.; Marinov, N. M. Fuel Process. Technol. 2000, vol. 65-66 (O), pp. 423-438). Niksa et al.'s (Niksa, S.; Helble, J. J.; Fujiwara, N. “Kinetic Modeling of Homogeneous Mercury Oxidation: the importance of NO and H₂O in predicting oxidation in coal-derived systems”; Environ. Sci. Technol. 2001, vol. 35, pp. 3701-3706) elementary reaction mechanism interpreted all these datasets within experimental uncertainty, and explained the apparent conflict with equilibrium thus: The application of quartz sampling probes in the tests imposed gas quench rates much faster than in a full-scale exhaust system. The faster quenching promoted superequilibrium Cl-atom concentrations that accelerated mercury oxidation in the gas phase and, once the HgCl₂ formed, it would not decompose into elemental mercury vapor because of the now-cooler temperature. Niksa et al. also demonstrated that, under some conditions, simply doubling the quench rate from 1000 to 2000° C./s (1800 to 3600° F./s) doubled the extent of Hg oxidation. Such modest accelerations of the normal gas quench rates in full-scale systems are definitely feasible.

The rate of mercury oxidation on particle surfaces is accelerated by the availability of more reactive surface area, which is obtained in practice with higher levels of unburned carbon in flyash. According to the art, higher unburned carbon levels are associated with greater measured values of flyash loss-on-ignition (LOI). The extents of Hg oxidation in Table 1 demonstrate that higher LOI increases the rate of mercury oxidation on particle surfaces. The proportions of oxidized mercury were measured (Gale, T. and Cushing, K.; EPRI-DOE-EPA-A&WMA Combined Utility Air Pollution Control Symposium: The MEGA Symp. 2003, EPRI) for five coals to cover broad ranges of both LOI and the coals' chlorine contents.

TABLE 1
Flue Gas from 1.0 MWₜ Furnace.

| Coal | Coal-Cl, daf wt. % | LOI, wt. % | % Oxidized Hg |
|---|---|---|---|
| Bit. #1 | 0.010 | 4.8 | 76.0 |
| Bit. #2 | 0.013 | 4.2 | 52.0 |
| Bit. #3 | 0.058 | 1.9 | 38.0 |
| | 0.058 | 9.8 | 55.0 |
| Bit. #4 | 0.280 | 1.7 | 46.0 |
| PRB | 0.013 | 0.2 | 18.7 |
| PRB | 0.013 | 0.2 | 30.0 |

As seen in Table 1, all the bituminous coals generated substantially more oxidized mercury than the PRB subbituminous. Bit. #1 and Bit. #2 both had unusually low Cl-levels which were either equal to or below the PRB's. Nevertheless, they generated more oxidized mercury than the PRB because the higher amounts of unburned carbon associated with their greater LOI values accelerated the mercury oxidation rates. In the tests series with Bit. #3, increasing the LOI by adjusting the furnace operating conditions enhanced the production of oxidized mercury. These data indicate that more of the available mercury will oxidize to mercuric chloride in the presence of higher levels of unburned carbon, all else being the same.

Utility boilers burning subbituminous coals like Powder River Basin (PRB) coal often have a high economizer outlet temperature to maintain sufficient primary air temperature for the high moisture PRB subbituminous fuel, which often lowers steam throughput. Consequently, over 90% of the coal-Hg is typically emitted as elemental mercury vapor, due to the combined effects of slow gas quenching and low UBC (0.3% LOI is typical). The inventive method overcomes both obstacles with minimal impact on normal operations to convert most of the coal-Hg into mercuric chloride and mercury bound to particulates.

Optimal quench rates in the correct flue gas temperature window act to initiate Cl-atom availability which, in turn, increases the availability of Cl₂. These chlorine species are highly reactive with Hg and HgCl, and will readily oxidize Hg to HgCl₂ by both gas-phase and heterogeneous mechanisms. However, the heterogeneous mechanism is controlled by the ability of the carbon particles to chlorinate, adsorb Hg and release HgCl from the surface of a chlorinated site. This chlorination and subsequent mercury oxidation occurs in a lower temperature window than Cl-atom activation. Thus, the quench rates at both the finishing super heater and economizer control the extent of Hg oxidation and must be optimized, even though Hg truly oxidizes at cooler temperatures. Kinetic simulations of the full process show extents of mercury oxidation above 90% and Hg retention rates over 70%, even for flue gases from subbituminous coals.

We performed actual testing at a 500 MW utility boiler firing PRB coal in January of 2004. The measured mercury emissions documented in these tests are summarized in Table 2.

TABLE 2
Test Site Current Mercury Emissions

| | | | Flue Gas | Flue Gas | Mercury |
|---|---|---|---|---|---|
| | Coal Hg | | % Hg⁺² | % Hg⁰ | Removal |
| Mean | 90 | ppb | 40.5% | 59.5% | 5% |
| Maximum | 150 | ppb | 75.3% | 94.8% | 10% |
| Minimum | 30 | ppb | 5.2% | 24.7% | 0% |

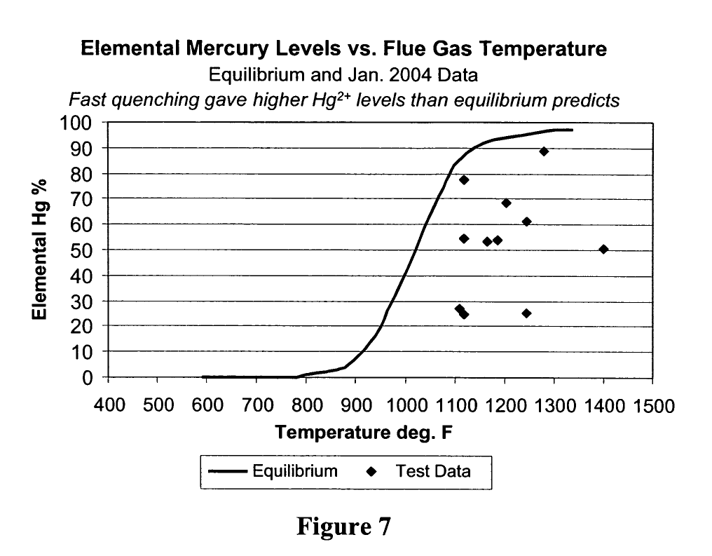

The tests showed that HgCl₂ can be formed in the flue gas at temperatures of 1100-1400° F. in far higher concentrations than the equilibrium values, and these levels could be attained by rapid quenching of the flue gas. Calculated probe quenching rates were 3250° F./sec. The measured percentages of elemental mercury vapor appear in FIG. 7 with equilibrium values.

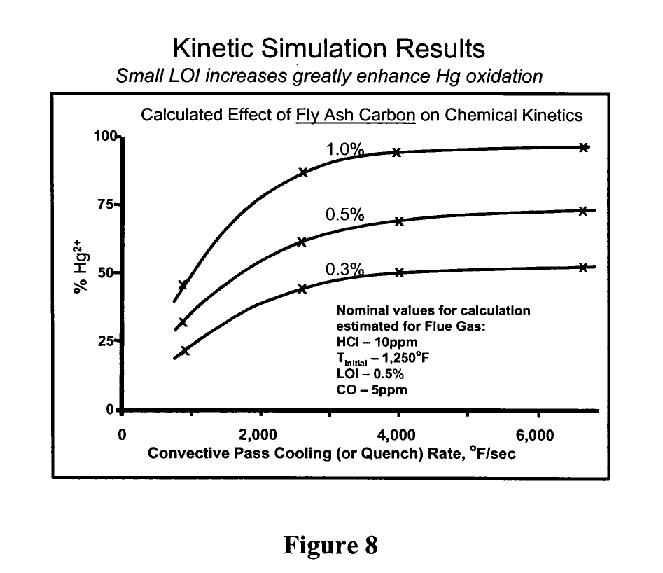

We also simulated Hg oxidation for the coal properties and operational data for selected furnaces. Simply increasing the quench rate in the superheater and economizer significantly enhances the extent of mercury oxidation from 21 to 54%. Most the enhancement is obtained by accelerating the quench rate by roughly a factor of 2.5. The effect of small changes in LOI is dramaticallyillustrated in FIG. 8. Increasing the LOI from 0.3 to 1.0% significantly enhances Hg oxidation at the baseline quench rate, from 21 to 45%. This enhancement is even larger for a quench rate of 2650° F./s, which raises the Hg oxidation from 44.7% to 85.7%. Most of the enhancement is obtained by this increase in quench rate. For the two faster quench rates, Hg oxidation rises to 91.0 and 92.3 for an LOI of only 1%. Since the curves in FIG. 8 are nearly parallel, one would expect higher levels of unburned carbon, or LOI, to enhance mercury removal in a similar way. Consequently, if the quench rate is near or less than 2000° F./s, one may increase the LOI above 1.0% to achieve higher levels of mercury capture.

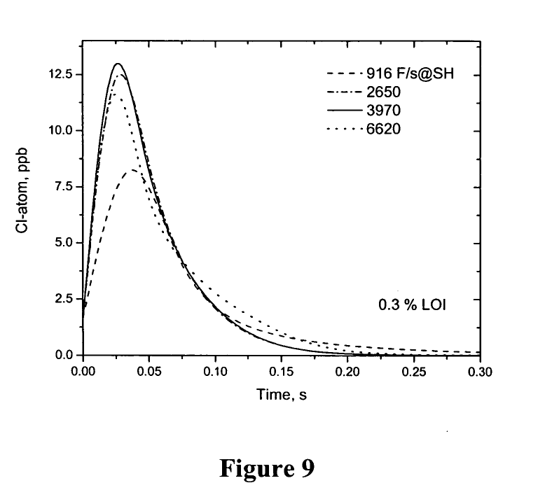

Faster quench rates accelerate mercury oxidation by increasing the concentrations of Cl-atoms and Cl₂. FIG. 9 shows Cl-atom concentrations growing from 7.6 to 16.7 ppb for progressively faster quench rates. The effect saturates, just as LOI enhancements saturated for the two fastest quench rates. The mechanism that relates the elevated Cl-atom concentrations to enhanced Hg oxidation was evident in the predicted rates of HgCl conversion. Much of the HgCl forms when Hg⁰ contacts a chlorinated site on a unburned carbon particle, because HgCl production via attack of elemental mercury vapor by a Cl-atom proceeds at a much slower rate. Once the HgCl desorbs back into the gas phase, its fate is determined by the following competitive reactions: 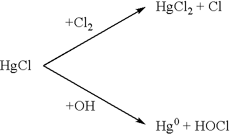
In the gas phase, HgCl is either oxidized by Cl₂ into HgCl₂ or disintegrated by OH into elemental mercury vapor and HOCl. When Cl is scarce, as in flue gas from low rank coals, the Cl₂ concentration determines the outcome of this competition. In the simulations, the steady-state Cl₂ concentration increased from 0.5 to 30 to 120 to 310 ppb when super heater quench rates were progressively increased from 916 to 2650 to 3970 to 6620° F./s. This surge in Cl₂ shifts the competitive reactions toward HgCl₂ production. The effect saturates when all the HgCl generated on unburned carbon is subsequently converted to HgCl₂ in the gas phase.

Higher levels of mercury can be removed from the flue gas when the furnace contains unburned carbon in the fly ash and the flue gas is rapidly quenched. The amount of unburned carbon in the flue gas can be increased by changing the operation of one or more burners to make combustion less efficient or by adding additional carbon to the flue gas. The easiest way of doing this is to change the flue air ratio in the combustion zone. Fast quenching can be obtained by the selection or modification of the economizer to increase surface area of the heat transfer tubes. Other ways of achieving these conditions that are known in the art could also be used.

The present method avoids the need to inject chlorine or chlorine components into the combustion system. However, one could make such an injection in addition to controlling the combustion process to provide unburned carbon and rapidly quenching the flue gas. However, such an injection may only be helpful in situations where coal having a very low chlorine content is being burned. If chlorine or chlorine compounds are injected the injection should be made in a zone immediately prior to the zone where rapid cooling of the flue gas occurs. Injections could be made through injectors 11 shown in FIG. 4.

We have focused on the formation of HgCl₂, but we would expect similar results if another halogen such as bromine or iodine were present and substituted for chlorine in the reactions here described. The rapid cooling will increase the concentration of halogen ions and elemental halogens Similarly, one may choose to inject another halogen or halogen compound in place of chlorine prior to rapidly quenching the flue gas.

Although we have described and illustrated certain present preferred embodiments of our method it is to be distinctly understood that the invention is not limited thereto, but may be variously embodied within the scope of the following claims.

We claim:

1. A method of removing mercury from flue gas produced by combustion devices burning mercury and chlorine containing fuel, the flue gas containing particles and passing from a combustion zone in which the temperature exceeds 2600° F., through a first temperature zone in which the temperatures range from 1750° F. to 2100° F., through a second temperature zone in which the temperatures range from 900° F. to 1450° F., through a particle removal device, and through a wet scrubber, the method comprising:
controlling the combustion process to generate a flue gas comprising fly! ash containing at least 0.25% unburned carbon;
rapidly cooling the flue gas from a temperature within the range of 1450° F. to 900° F. to a temperature below 900° F. at a rate of at least 1000° F. per second to enhance the concentrations of Cl-atoms and Cl₂;
directing the flue gas to the particle removal device for removal of the fly ash to which some of the mercury is bound; and
directing the flue gas to wet scrubbers for retention of the oxidized mercury vapor in wastewater and solid effluents.

2. The method of claim 1, comprising controlling the combustion process to produce a fly ash containing at least 0.3 weight percent carbon.

3. The method of claim 1, controlling the combustion process to produce a fly ash containing at least 1.0 weight percent carbon.

4. The method of claim 1 wherein the flue gas is rapidly cooled to a temperature below 650° F.

5. The method of claim 1 wherein the flue gas is rapidly cooled at a rate of at least 1500° F. per second.

6. A method of removing mercury from flue gas produced by combustion devices burning mercury and at least one halogen containing fuel, the flue gas containing particles and passing from a combustion zone in which the temperature exceeds 2600° F., through a first temperature zone in which the temperatures range from 1750° F. to 2100° F., through a second temperature zone in which the temperatures range from 900° F. to 1450° F., through a particle removal device, and through a wet scrubber, the method comprising:
controlling the combustion process to generate a flue gas comprising fly ash containing at least 0.25% unburned carbon;
rapidly cooling the flue gas from a temperature within the range of 1450° F. to 900° F. to a temperature below 900° F. at a rate of at least 1000° F. per second to enhance the concentrations of halogen atoms and elemental halogens;
directing the flue gas to the particle removal device for removal of the fly ash to which some of the mercury is bound; and
directing the flue gas to wet scrubbers for retention of the oxidized mercury vapor in wastewater and solid effluents.

7. The method of claim 6, comprising controlling the combustion process to produce a fly ash containing at least 0.3 weight percent carbon.

8. The method of claim 6, controlling the combustion process to produce a fly ash containing at least 1.0 weight percent carbon.

9. The method of claim 6 wherein the flue gas is rapidly cooled to a temperature below 650° F.

10. The method of claim 6 wherein the flue gas is rapidly cooled at a rate of at least 1500° F. per second.
